(19) United States
(12) Patent Application Publication
(10) Pub. No.: US 2014/0297275 A1
(43) Pub. Date: Oct. 2, 2014

(54) SPEECH PROCESSING DEVICE, INTEGRATED CIRCUIT DEVICE, SPEECH PROCESSING SYSTEM, AND CONTROL METHOD FOR SPEECH PROCESSING DEVICE

(71) Applicant: SEIKO EPSON CORPORATION, Tokyo (JP)

(72) Inventor: Shoji HOSHINA, Kawasaki-shi (JP)

(73) Assignee: SEIKO EPSON CORPORATION, Tokyo (JP)

(21) Appl. No.: 14/187,999

(22) Filed: Feb. 24, 2014

(30) Foreign Application Priority Data
Mar. 27, 2013 (JP) 2013-067149

(51) Int. Cl. G10L 15/00

(52) U.S. Cl. CPC G10L 15/00
USPC 704/231

(57) ABSTRACT

A speech processing device includes: a dialog execution control unit that controls speech output and timings of speech recognition in accordance with dialog information including speech output information, speech recognition information and control information; a speech output control unit that outputs an output speech signal designated by the speech output information; and a speech recognition unit that executes speech recognition processing for an input speech signal using the speech recognition information. The control information includes speech output timing information for the output speech signal and speech recognition start timing information for the input speech signal. The speech recognition start timing information is specified by a time period that elapses from a first timing specified by the speech output timing information.

### CROSS-REFERENCE TO RELATED APPLICATIONS

This application claims priority to Japanese Patent Application No. 2013-067149 filed on Mar. 27, 2013. The entire disclosure of Japanese Patent Application No. 2013-067149 is hereby incorporated herein by reference.

### BACKGROUND

1. Technical Field

The present invention relates to a speech processing device, a speech processing system, and a control method for a speech processing device.

2. Related Art

A speech recognition technique for recognizing specific words based on human speech has been developed. Furthermore, ideas for controlling various types of devices using the speech recognition technique have been proposed.

In the field of systems for such speech processing, development of interactive (dialog-based) devices is being carried out. The interactive devices conduct speech recognition by displaying a speech guidance and text information and acquiring speech made by a user in response to the displayed speech guidance and text information. Pieces of information necessary for a dialog, such as a speech guidance and text information, are collectively prepared as scenarios. JP-A-2007-108524, which is an example of related art, describes a speech input evaluation device that provides interactive training using a scenario selected from a plurality of scenarios.

With interactive (dialog-based) speech processing devices that output a speech guide and text information and conduct speech recognition in accordance with the output speech guide and text information, it is necessary to manage timings for outputting the speech guide and text information and conducting speech recognition. The timings for outputting the speech guide and text information and conducting speech recognition may be managed by applications of apparatuses (hosts) that use the speech processing devices. In this case, however, applications for timing management are not easy to develop, and the processing load on the apparatuses (hosts) is increased. Furthermore, it is not easy to edit a speech guide, speech recognition, display information, and the like after installing scenarios in speech processing devices.

### SUMMARY

An advantage of some aspects of the invention is to enable provision of an integrated circuit device, a speech processing device and a speech processing method that facilitate management of an output timing of at least one of a speech guide and text information, as well as a timing of speech recognition, in the case of interactive (dialog-based) speech recognition whereby speech recognition is conducted by outputting at least one of the speech guide and the text information.

### FIRST APPLICATION EXAMPLE

One aspect of the invention is as follows. A speech processing device according to the present application example includes: a dialog execution control unit that controls speech output and timings of speech recognition in accordance with dialog information including speech output information, speech recognition information and control information; a speech output control unit that outputs an output speech signal designated by the speech output information under control of the dialog execution control unit; and a speech recognition unit that executes speech recognition processing for an input speech signal using the speech recognition information under control of the dialog execution control unit. Here, the control information includes speech output timing information for the output speech signal and speech recognition start timing information for the input speech signal. Also, the speech recognition start timing information is specified by a time period that elapses from a first timing specified by the speech output timing information.

In this configuration, the speech processing device includes the dialog execution control unit, the speech output control unit and the speech recognition unit. The dialog execution control unit controls speech output and timings of speech recognition in accordance with the dialog information including the speech output information, the speech recognition information and the control information. The speech output control unit outputs the output speech signal designated by the speech output information under control of the dialog execution control unit. The speech recognition unit executes speech recognition processing for an input speech signal using the speech recognition information under control of the dialog execution control unit. The control information includes the speech output timing information for the output speech signal and the speech recognition start timing information for the input speech signal. The speech recognition start timing information is specified by a time period that elapses from the first timing specified by the speech output timing information. In this way, a timing for starting the speech recognition processing can be set in association with an output timing of speech, such as a speech guide. This not only facilitates management of processing information, but also enables suspension of the speech recognition processing in a time period in which a user of the speech processing device is determined to be unresponsive. As a result, a reduction in power consumption can be ensured without bringing an unnatural experience to the user.

### SECOND APPLICATION EXAMPLE

In the speech processing device according to the above-referenced application example, it is preferable that the dialog information include two or more pieces of the speech output information, and the speech output timing information that specifies output of a predetermined one of the pieces of speech output information be specified by a time period that elapses from completion of output control for one of the pieces of speech output information that is output immediately before the predetermined piece of speech output information.

In this configuration, as the dialog information includes two or more pieces of speech output information, a large amount of information can be conveyed to the user as speech compared to the case where the user is guided by one piece of speech output information. Furthermore, in this configuration, the speech output timing information that specifies output of a predetermined piece of speech output information is specified by a time period that elapses from completion of output control for one of the pieces of speech output information that is output immediately before the predetermined piece of speech output information. As a result, an appropriate time interval can be maintained from one speech output to another. Such speech output is listenable for the user.

### THIRD APPLICATION EXAMPLE

It is preferable that the speech processing device according to any of the above-referenced application examples further include a dialog storage unit that stores the dialog information.

In this configuration, as the dialog storage unit is further included, many pieces of dialog information can be held. Therefore, the speech processing device can be utilized in a wider field without rewriting the dialog information.

### FOURTH APPLICATION EXAMPLE

In the speech processing device according to any of the above-referenced application examples, it is preferable that the first timing be specified by the speech output timing information corresponding to a piece of speech output information that is output last out of pieces of the speech output information included in the dialog information.

In this configuration, the first timing is specified by the speech output timing information corresponding to a piece of speech output information that is output last out of pieces of speech output information included in the dialog information. This can facilitate determination of the extent of a time period that should elapse until the start of the speech recognition processing. As a result, internal control of the speech processing device can be performed appropriately, and a reduction in power consumption can be ensured in a more preferable manner.

### FIFTH APPLICATION EXAMPLE

In another aspect of the invention, an integrated circuit device includes the speech processing device according to any of the above-referenced application examples.

This enables construction of an integrated circuit device including a speech processing device that ensures a reduction in power consumption.

### SIXTH APPLICATION EXAMPLE

A further aspect of the invention is as follows. A speech processing system according to the present application example includes: a speech processing device; a speech input unit; an information display unit; and a speech output unit. Here, the speech processing device includes: a dialog execution control unit that controls speech output and timings of speech recognition in accordance with dialog information including speech output information, speech recognition information and control information; a speech output control unit that controls the speech output unit, and outputs an output speech signal designated by the speech output information under control of the dialog execution control unit; and a speech recognition unit that executes speech recognition processing for an input speech signal output from the speech input unit using the speech recognition information under control of the dialog execution control unit. Also, the control information includes speech output timing information for the output speech signal, speech recognition start timing information for the input speech signal, and display start timing information for the information display unit. Furthermore, the speech recognition start timing information and the display start timing information are specified by a time period that elapses from a first timing specified by the speech output timing information.

In this configuration, the speech processing system includes the speech processing device, the speech input unit, the information display unit, and the speech output unit. Also, the speech processing device includes the dialog execution control unit, the speech output control unit and the speech recognition unit. Furthermore, the speech recognition start timing information and the display start timing information included in the control information of the dialog information are specified by a time period that elapses from a first timing specified by the speech output timing information. In this way, a display start timing of display information and a timing for starting the speech recognition processing can be set in association with an output timing of speech, such as a speech guide. This enables suspension of the speech recognition processing in a time period in which a user of the speech processing device is determined to be unresponsive. As a result, a reduction in power consumption can be ensured without bringing an unnatural experience to the user.

### SEVENTH APPLICATION EXAMPLE

In the speech processing system according to the above-referenced application example, it is preferable that the first timing be specified by the speech output timing information corresponding to a piece of speech output information that is output last out of pieces of the speech output information included in the dialog information.

In this configuration, the first timing is specified by the speech output timing information corresponding to a piece of speech output information that is output last out of pieces of speech output information included in the dialog information. This can facilitate determination of the extent of a time period that should elapse until the start of display and the start of the speech recognition processing. As a result, internal control of the speech processing device can be performed appropriately, and a reduction in power consumption can be ensured in a more preferable manner.

### EIGHTH APPLICATION EXAMPLE

A still further aspect of the invention is as follows. A control method for a speech processing device according to the present application example includes: establishing dialog information that includes speech output information, speech recognition information and control information, the control information including speech output timing information and speech recognition start timing information; outputting the speech output information in accordance with the speech output timing information; and executing speech recognition processing using the speech recognition information in accordance with the speech recognition start timing information. Here, the speech recognition start timing information is specified by a time period that elapses from a first timing specified by the speech output timing information.

The control method includes: establishing the dialog information; outputting the speech output information in accordance with the speech output timing information included in the control information of the dialog information; and executing the speech recognition processing using the speech recognition information in accordance with the speech recognition start timing information included in the control information of the dialog information. Also, according to the control method, the speech recognition start timing information is specified by a time period that elapses from a first timing specified by the speech output timing information. In this way, a timing for starting the speech recognition processing can be set in association with an output timing of speech, such as a speech guide. This enables suspension of the speech recognition processing in a time period in which a user of the speech processing device is determined to be unresponsive. As a result, a reduction in power consumption can be ensured without bringing an unnatural experience to the user.

### NINTH APPLICATION EXAMPLE

It is preferable that the control method for the speech processing device according to the above-referenced application example further include executing display processing using display information in accordance with display start timing information, the display information being included in the dialog information, and the display start timing information being included in the control information. In the control method, it is also preferable that the display start timing information be specified by a time period that elapses from the first timing.

According to the above-referenced control method, the dialog information includes the display information, the control information of the dialog information includes the display start timing information, the display start timing information is specified by a time period that elapses from the first timing, and the method further includes executing the display processing using the display information in accordance with the display start timing information. This can facilitate determination of the extent of a time period that should elapse until the start of display. In this way, a user-friendly speech processing device can be constructed.

### BRIEF DESCRIPTION OF THE DRAWINGS

The invention will be described with reference to the accompanying drawings, wherein like numbers reference like elements.

FIG. 1 is a functional block diagram showing a speech processing device.

FIGS. 2A and 2B show examples of dialog information.

FIG. 3 shows a timeline of execution of dialog information.

FIGS. 4A and 413 show relationships between pieces of dialog information.

FIG. 5 shows an example of dialog information.

FIG. 6 shows an example of scenario composition.

FIG. 7 is an explanatory diagram showing information related to a start timing of a next dialog.

FIG. 8 shows an example of a configuration of a speech processing system.

FIG. 9 shows another example of a configuration of a speech processing system.

### DESCRIPTION OF EXEMPLARY EMBODIMENTS

The following describes preferred embodiments of the invention in detail with reference to the drawings. It should be noted that the embodiments described below are not intended to unreasonably limit the contents of the invention described in the attached claims. Furthermore, not all configurations described below are constituent elements indispensable for the invention. The drawings will be referred to for the sake of convenient description.

### First Embodiment

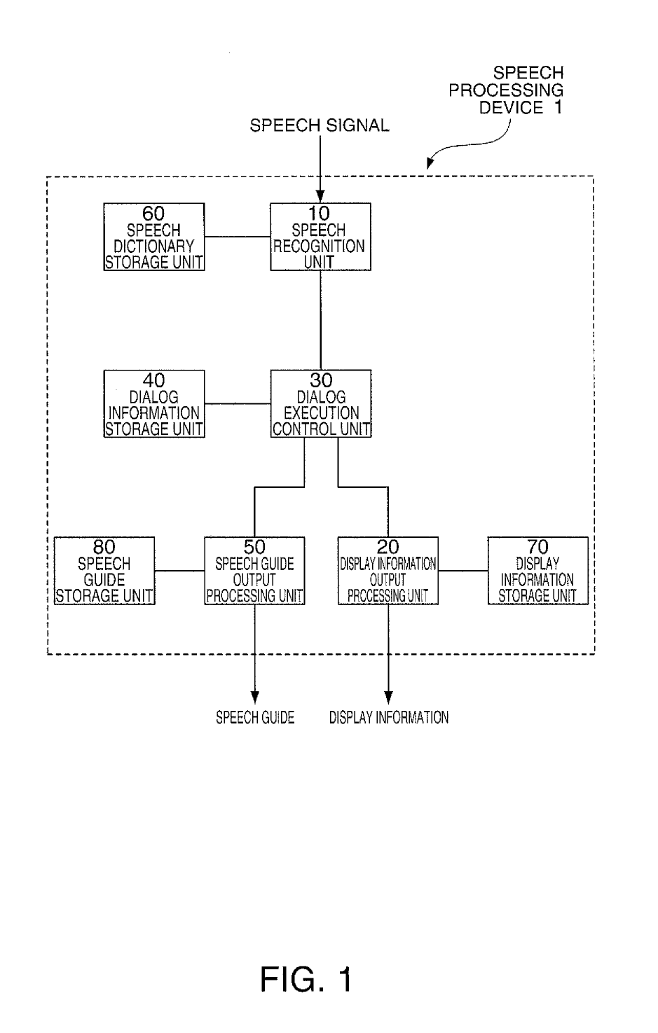

FIG. 1 is a functional block diagram showing a speech processing device 1 according to the present embodiment. The speech processing device 1 includes a speech recognition unit 10, a display information output processing unit 20, a dialog execution control unit 30, a dialog information storage unit 40, a speech guide output processing unit 50, a speech dictionary storage unit 60, a display information storage unit 70, and a speech guide storage unit 80. Speech input from a speech input device, which is not shown in the drawings, is input to the speech recognition unit 10 as a speech signal. Display information output from the display information output processing unit 20 is displayed by a display unit, which is not shown in the drawings. A speech guide output from the speech guide output processing unit 50 is output from a speech output unit, which is not shown in the drawings, as speech.

The speech recognition unit 10 conducts speech recognition with respect to the input speech signal. A time period in which speech recognition processing is executed is controlled by a signal output from the dialog execution control unit 30.

The display information output processing unit 20 executes processing for outputting the display information. An output timing of the display information is controlled by a signal output from the dialog execution control unit 30.

The dialog execution control unit 30 controls the speech recognition unit 10, the display information output processing unit 20, the speech guide output processing unit 50, and the like based on dialog information stored in the dialog information storage unit 40, which will be described later. The dialog information includes, for example, speech output information, display information and speech recognition information for a predetermined scene, as well as control information for these pieces of information.

Note that the speech output information included in the dialog information may be selection information for selecting predetermined speech data from among a plurality of pieces of speech data, such as phrases, prestored in the speech guide storage unit 80, or may be speech data itself. In the case where the speech output information is speech data itself, speech synthesis processing is applied to the speech data included in the dialog information, and the resultant speech data is output as a speech guide.

Similarly, the display information included in the dialog information may be selection information for selecting predetermined display data from among a plurality of pieces of display data that are included in the display information in advance, or may be display data itself. In the case where the display information is display data itself, the display information included in the dialog information is output as display information.

The dialog information storage unit 40 stores the dialog information.

The speech guide output processing unit 50 generates a speech signal by, for example, executing speech synthesis in accordance with an instruction from the dialog execution control unit 30, and outputs the generated speech signal as a speech guide.

The speech dictionary storage unit 60 stores a speech recognition database that is used by the speech recognition unit 10 in the speech recognition processing. Speech recognition is conducted by comparing an input speech signal with data in the speech recognition database. Note that the speech recognition processing can be executed using various types of known methods. For example, the speech recognition processing may be executed using a hidden Markov model or a direct matching method. In the present embodiment, the method or processing for speech recognition itself is not limited to a particular method or particular processing.

The dialog execution control unit 30 executes dialog information. More specifically, the dialog execution control unit 30 identifies dialog information to be executed, analyzes the identified dialog information, and outputs a control signal and provides data to any unit in the speech processing device 1 that needs to execute processing.

Upon occurrence of a given event, the dialog execution control unit 30 starts execution of given dialog information corresponding to the given event. Based on the contents of the given dialog information, the dialog execution control unit 30 controls the speech guide output processing unit 50 to output a speech guide. Thereafter, the dialog execution control unit 30 controls the display information output processing unit 20 at a predetermined timing to output display information. Similarly, the dialog execution control unit 30 controls the speech recognition unit 10 at a predetermined timing to execute speech recognition processing with respect to the input speech signal. The result of the speech recognition processing is transferred to the dialog execution control unit 30. Subsequently, the result of the speech recognition processing is presented to a user by the display information output processing unit 20 displaying the same on the display unit, or by the speech guide output processing unit 50 outputting the same as speech, in accordance with an instruction from the dialog execution control unit 30.

Note that the speech processing device 1 may be used by itself, or may be connected to another device for use. Alternatively, the speech processing device 1 may be assembled into any device for use. Alternatively, a host device for controlling the speech processing device 1 may be connected thereto. In the case where the host device is connected, dialog information may be provided from the host device in advance so as to be stored in the dialog information storage unit 40, or each individual piece of dialog information may be provided from the host device on a per-execution basis. Similarly, data stored in the display information storage unit 70 and the speech guide storage unit 80 may be provided from the host device in advance, or may be provided from the host device on a per-execution basis.

Note that the given event may be reception of a command and a trigger signal from the host device, or may be an event generated by the speech processing device itself, e.g. an event that has occurred as a result of execution of previous dialog information.

Also, noise removal and the like may be applied to a speech signal input to the speech processing device 1 using, for example, an A/D converter and a filter, which are not shown in the drawings.

Using a simple example of dialog information, the following describes the operations of the speech processing device 1 based on the dialog information.

### Working Example 1

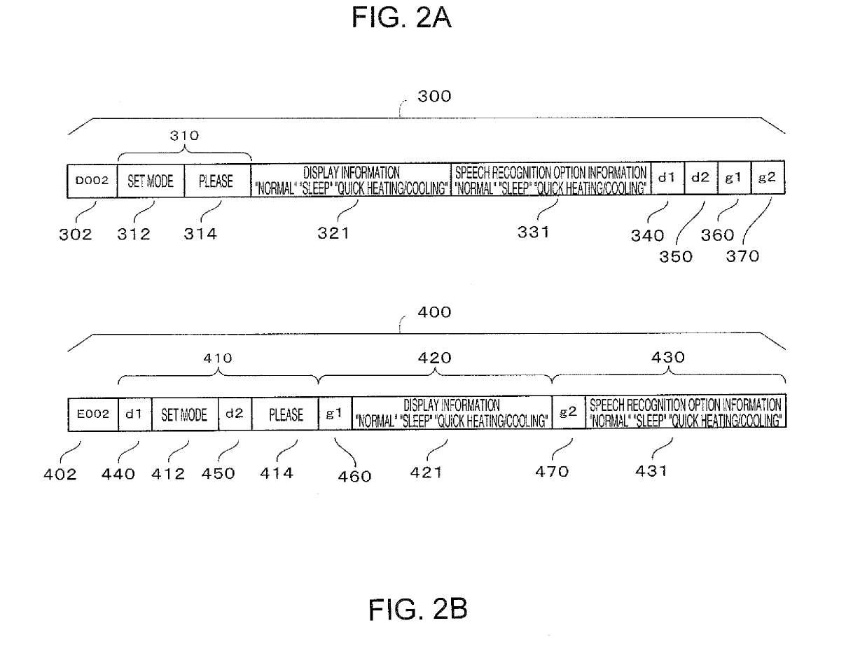

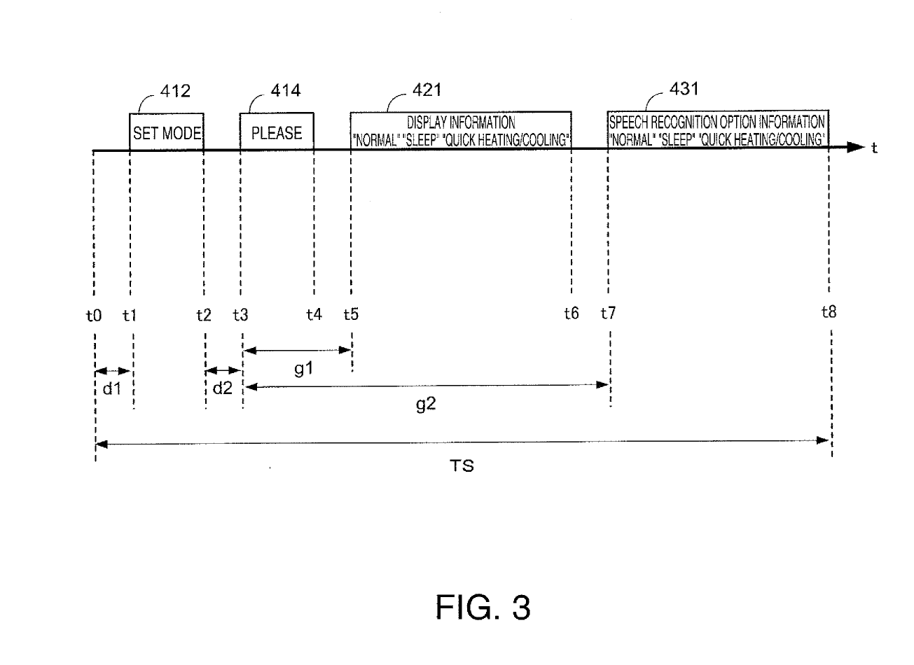

In the present working example, the invention is applied to a remote control device for an air conditioner (not shown in the drawings). FIGS. 2A and 2B show formats of dialog information. FIG. 3 schematically shows a timeline of the dialog information shown in FIG. 23. It will be assumed that a display unit is mounted on the remote control device. Note that dialog information used in the present working example is executed when setting one of operation modes of the air conditioner.

FIG. 2A shows dialog information formatted such that pieces of control information are collectively arranged in the last portion of the dialog information. Dialog information 300 shown in FIG. 2A is composed of a dialog number 302, speech guide control information 310 (speech guide information 312 and speech guide information 314), display information 321, speech recognition option information 331, and a plurality of pieces of timing information (timing information 340 (d1), timing information 350 (d2), timing information 360 (g1), and timing information 370 (g2)). Although not shown in the drawings, each piece of information is assigned a tag for identifying the information. The dialog number 302 is a number indicating the dialog information 300.

The timing information 340 (d1) is control information for specifying an output timing of the speech guide information 312, which is output first. Once the dialog execution control unit 30 has started the execution of the dialog information 300, the dialog execution control unit 30 instructs the speech guide output processing unit 50 to output the speech guide information 312 upon elapse of a time period specified by the timing information 340 (d1). Consequently, the speech guide output processing unit 50 executes speech output processing. When the speech output processing for the speech guide information 312 is completed, the speech guide output processing unit 50 notifies the dialog execution control unit 30 of the completion of the processing. At this point, a phrase “set mode” has been output as speech.

Then, upon elapse of a time period specified by the timing information 350 (d2), the dialog execution control unit 30 instructs the speech guide output processing unit 50 to output the speech guide information 314 and starts measurements of the timing information 360 (g1) and the timing information 370 (g2).

In response to the instruction from the dialog execution control unit 30, the speech guide output processing unit 50 executes speech output processing. When the processing is completed, the speech guide output processing unit 50 notifies the dialog execution control unit 30 of the completion of the processing. At this point, a phrase “please” has been output as speech. Thus far, two phrases “set mode” and “please” have been output as speech guides with a time interval of d2 therebetween. This enables the user to recognize the speech guides as natural, listener-friendly speech resembling human speech.

When the measurement of the timing information 360 (g1) is completed, the dialog execution control unit 30 instructs the display information output processing unit 20 to display the display information 321. Consequently, the words “normal cooling/heating”, “sleep cooling/heating”, and “quick cooling/heating” are displayed on the display unit of the remote control device.

When the measurement of the timing information 370 (g2) is completed, the dialog execution control unit 30 outputs the speech recognition option information 331 to the speech recognition unit 10, and instructs the speech recognition unit 10 to start speech recognition processing for an input speech signal. Thereafter, when the speech recognition unit 10 completes the speech recognition processing, the speech recognition unit 10 notifies the dialog execution control unit 30 of the completion of the processing together with the result of the processing. The dialog execution control unit 30 executes processing corresponding to the result of the speech recognition processing (for example, generates a corresponding control signal), and completes the execution of the dialog information 300.

As opposed to FIG. 2A, FIG. 2B shows dialog information formatted such that control information is arranged immediately before data to be used. Contents of pieces of information included in dialog information 400 shown in FIG. 2B are similar to contents of pieces of information included in the dialog information 300. However, the order in which these pieces of information are arranged differ between the dialog information 400 and the dialog information 300. The dialog information 400 includes a dialog number 402, speech guide control information 410, display control information 420, and speech recognition control information 430.

The speech guide control information 410 includes speech guide information 412, timing information 440 (d1) for the speech guide information 412, speech guide information 414, and timing information 450 (d2) for the speech guide information 414.

The display control information 420 includes display information 421 and timing information 460 (g1) for the display information 421.

The speech recognition control information 430 includes speech recognition option information 431 and timing information 470 (g2) for the speech recognition option information 431.

There is no particular restriction on the choice of which one of the formats shown in FIGS. 2A and 2B should be used. It is sufficient to select and use any format that fits the use of the speech processing device. In the invention, pieces of information included in dialog information are not limited to being arranged in a specific manner. It is sufficient to format them in a manner preferable for the speech processing device 1 or for a device connected to the speech processing device 1. Furthermore, the number of phrases set by the dialog information 300 and the dialog information 400 is not limited to a specific number. The dialog information 300 and the dialog information 400 may include any number of pieces of speech guide information and speech timing information commensurate with the number of necessary phrases.

The timeline shown in FIG. 3 pertains to the case of the dialog information 400. However, a similar timeline is applicable also in the case of the dialog information 300. In FIG. 3, a horizontal axis t represents a time axis (a time axis indicating local time within one dialog).

Time t0 denotes a start timing of the dialog information 400. Playback of a speech guide of the first phrase “set mode” is started at time t1, which is after the dialog start time t0 by the timing information 440 (d1). The playback of the speech guide “set mode” is completed at time t2. Then, playback of a speech guide of the next phrase “please” 414 is started at time t3, which is after time t2 by the timing information 450 (d2).

At time t3, measurements of the timing information 460 (g1) and the timing information 470 (g2) are started. Display of the display information 421 is executed at time t5, which is after time t3 by the timing information 460 (g1). The speech recognition option information 431 is output to the speech recognition unit 10 and the speech recognition processing is started at time t7, which is after time t3 by the timing information 470 (g2).

While FIG. 3 depicts the case where the speech recognition processing is started after the display information is displayed, there is no particular restriction on time periods specified by the timing information 460 (g1) and the timing information 470 (g2). The speech recognition processing may be started before the display information 421 is displayed by making a time interval specified by the timing information 470 (g2) shorter than a time interval specified by the timing information 460 (g1).

### Second Embodiment

The present embodiment pertains to an exemplary case where a plurality of pieces of dialog information are executed in succession.

For example, more complicated control of a device can be realized by combining a plurality of pieces of dialog information into one scenario and selecting one or more pieces of dialog information to be executed in accordance with a response from a user.

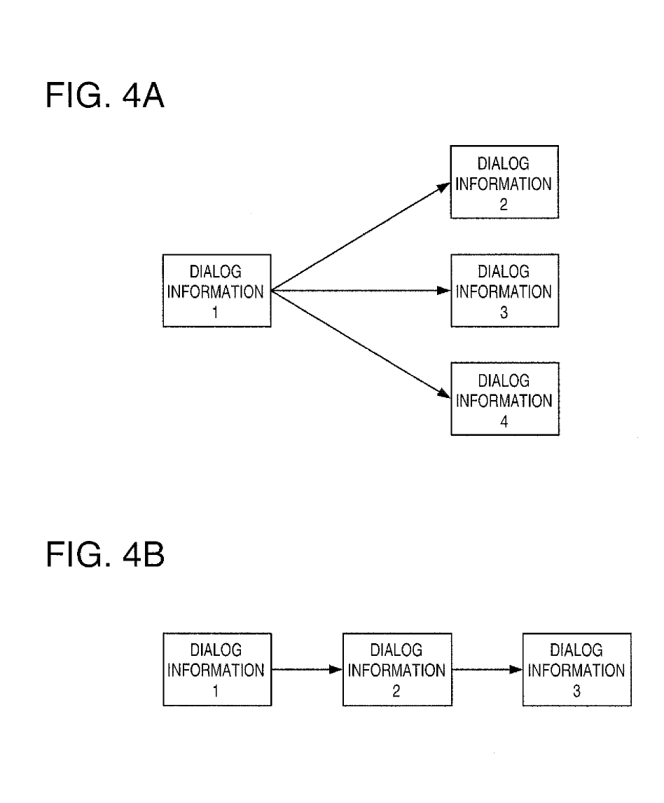

FIGS. 4A and 4 (B) show forms of transition of dialog information. FIG. 4A depicts the case where execution of a plurality of pieces of dialog information depends on the result of execution of previous dialog information, whereas FIG. 43 depicts the case where a plurality of pieces of dialog information are executed in a preset order.

In the case of FIG. 4A, speech recognition information includes options 1 to 3 as responses to a question posed by a speech guide of dialog information 1, and pieces of dialog information 2 to 4 are prepared in one-to-one correspondence with the options 1 to 3. That is to say, dialog information n corresponding to an option n that has been selected as a result of execution of the dialog information 1 will be executed next.

In the case of FIG. 4B, after the dialog information 1 is executed, the dialog information 2 is executed regardless of the result of execution of the dialog information 1 (for example, the result of speech recognition). Then, after the dialog information 2 is executed, the dialog information 3 is executed regardless of the result of execution of the dialog information 2.

In either of the forms of FIGS. 4A and 4B, it is necessary to designate dialog information to be executed next. It is sufficient to designate dialog information using a dialog number.

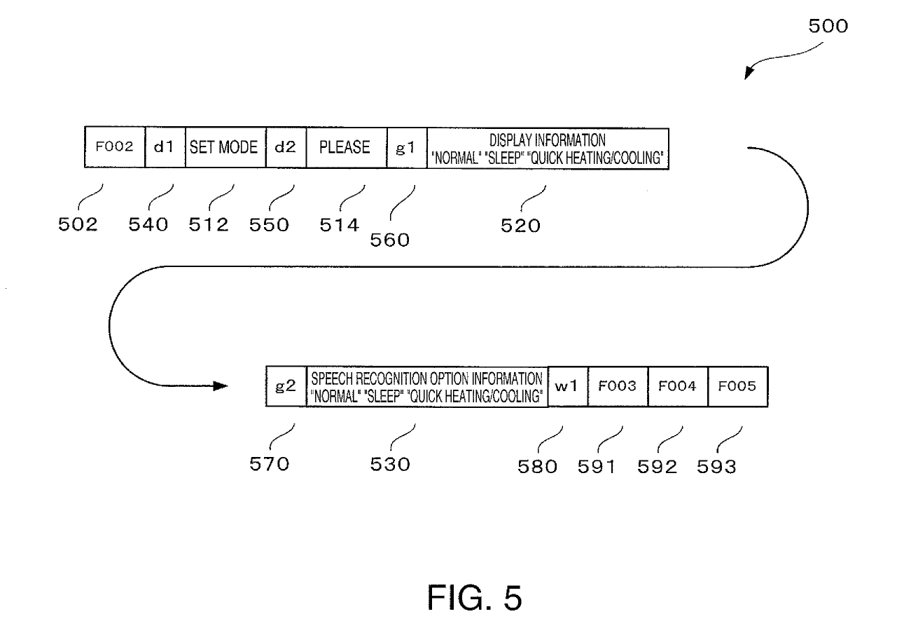

FIG. 5 shows an example of dialog information 500 including dialog information to be executed next. The dialog information 500 is composed of a dialog number 502, speech guide information 512, speech guide information 514, display information 520, speech recognition information 530, timing information 540, timing information 550, timing information 560, timing information 570, dialog interval information 580, next-stage dialog information 591, next-stage dialog information 592, and next-stage dialog information 593.

The dialog information 500 includes the following three options for speech recognition processing: “normal cooling/heating”, “sleep cooling/heating”, and “quick cooling/heating”. If “normal cooling/heating” is selected, dialog information assigned a dialog number indicated by the next-stage dialog information 591 is executed. If “sleep cooling/heating” is selected, dialog information assigned a dialog number indicated by the next-stage dialog information 592 is executed. If “quick cooling/heating” is selected, dialog information assigned a dialog number indicated by the next-stage dialog information 593 is executed.

The dialog interval information 580 indicates a time interval from when the result of speech recognition processing is achieved in execution of the dialog information 500 to when execution of the next dialog information is started. Note that the dialog execution control unit 30 may read dialog information that needs to be executed from the dialog information storage unit 40 and the like either in advance or during the time interval specified by the dialog interval information 580.

Also, the form shown in FIG. 4B can be similarly dealt with by assigning the same dialog number to the pieces of next-stage dialog information 591 to 593. Furthermore, in the case of the form shown in FIG. 4B, one area may be provided in FIG. 5 to define dialog information to be executed next.

### Working Example 2

In the present working example, a description is given of transition of dialog information to be executed in execution of a scenario for a remote control device that operates an air conditioner, a television and a lighting device.

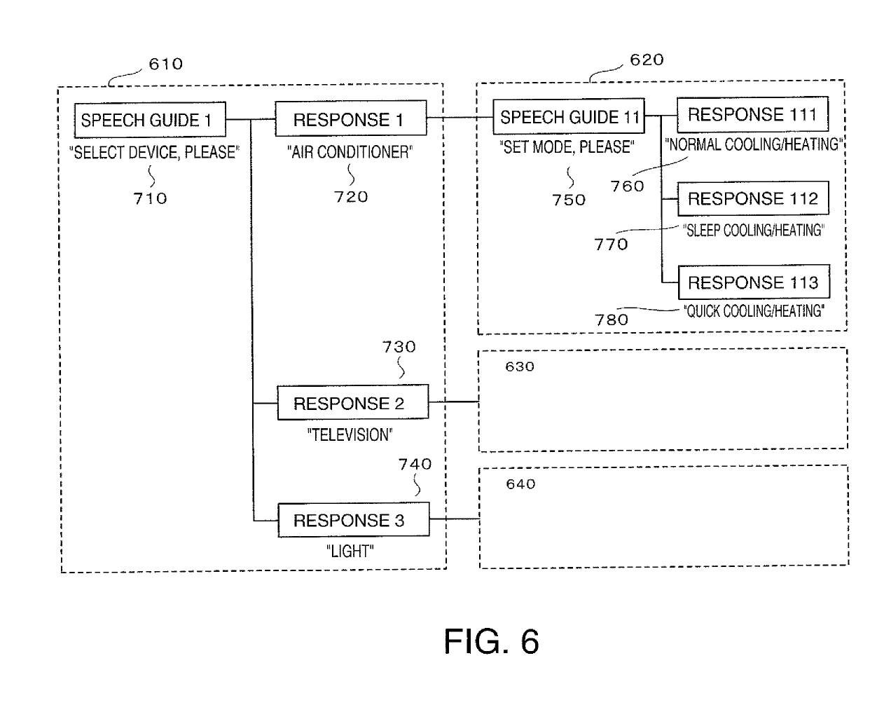

FIG. 6 shows a relationship between pieces of dialog information to be executed (scenario composition). In FIG. 6, dialog images 610 to 640 are shown. A dialog image is a diagrammatic presentation of a part of contents of dialog information. The remote control device first selects a device to be operated, and then operates the selected device.

The scenario composition shown in FIG. 6 corresponds to the form shown in FIG. 4A. The dialog image 610 corresponds to the dialog information 1 of FIG. 4A. Similarly, the dialog images 620, 630 and 640 correspond to the pieces of dialog information 2, 3 and 4 of FIG. 4A, respectively.

The dialog image 610 shows dialog information that is executed first (hereinafter referred to as the dialog information 1). In the dialog information 1, a phrase 710 (“select device, please”, speech guide 1) is set as the first question that marks the start of a dialog, and the following plurality of options are set for the phrase 710: a phrase 720 as a response 1 (“air conditioner”, option 1), a phrase 730 as a response 2 (“television”, option 2), and a phrase 740 as a response 3 (“light”, option 3).

In the present embodiment, for example, if the speech guide 1 is output, speech recognition processing is executed for language models corresponding to phrases of the responses 1 to 3, which are the plurality of options corresponding to the speech guide 1. Then, one of the phrases that matches a response speech made by the user is determined. Based on the result of the determination, for example, a speech guide to be output next is selected, or whether or not to end the dialog is determined.

Pieces of dialog information are prepared in one-to-one correspondence with the options. If the result of the speech recognition processing in the dialog image 610 is the response 1, the dialog image 620 (hereinafter referred to as the dialog information 2) is executed next. In the dialog information 2, a phrase 750 (“select mode, please”, speech guide 11) is set as the first question that marks the start of a dialog, and the following plurality of options are set for the phrase 750: a phrase 760 as a response 111 (“normal cooling/heating”, option 1), a phrase 770 as a response 112 (“sleep cooling/heating”, option 2), and a phrase 780 as a response 113 (“quick cooling/heating”, option 3).

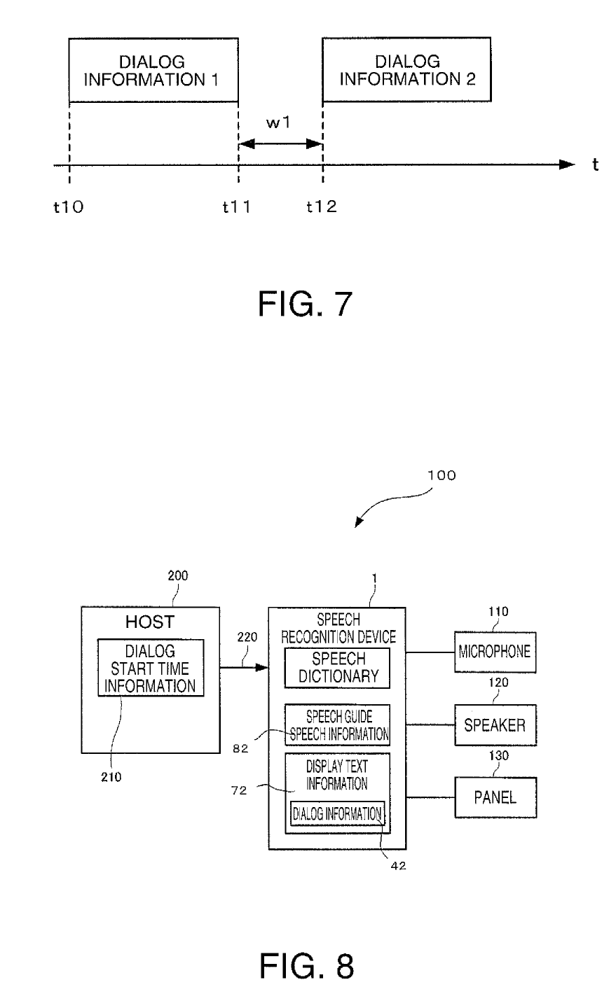

FIG. 7 is an explanatory diagram showing a start timing of a next dialog.

In FIG. 7, a horizontal axis t represents a time axis (a time axis for managing a plurality of dialogs associated with one another). It will be assumed that a start timing of the dialog information 1 is time t10, an end timing of the dialog information 1 is time t12, and a start timing of the dialog information 2 is time t13. A time interval between time t13 and time t12 is specified by the dialog interval information 580.

The speech processing device 1 manages timings in accordance with specified dialog information. This allows for reduction in the load on development of applications for a system including the speech processing device 1, as well as reduction in the processing load on a host of the speech processing device 1.

### Third Embodiment

The present embodiment presents an example of a system including the speech processing device 1.

### Working Example 3

FIG. 8 shows an example of a configuration of a speech processing system 100 according to the present embodiment.

The speech processing system 100 includes the speech processing device 1 and a host 200.

The host 200 may be a processor (for example, CPU) of a device in which the speech processing system 100 is configured. For example, the host 200 may hold dialog start time information 210 and issue a dialog start request 220 (an example of a given event) to the speech processing device 1 at dialog start time. The dialog start request 220 may be transmitted as, for example, a command and a trigger signal.

The speech processing device (integrated circuit device) 1 includes the constituent elements described with reference to FIG. 1, and also holds dialog information 42. The dialog information may be installed in the speech processing device 1 in advance, or may be received from the host 200 and stored in a storage unit at a given timing.

The dialog start request 220 from the host 200 causes the speech processing device (integrated circuit device) 1 to start execution of a dialog. In accordance with the dialog information 42 of the executed dialog, a speech guide (speech guide information 82) is output from a speaker 120. Also, in accordance with the dialog information 42 of the executed dialog, a display text (display text information 72) is displayed on a panel 130. Furthermore, in accordance with the dialog information 42 of the executed dialog, speech recognition is conducted for speech input from a microphone 110.

The speech processing device 1 may or may not notify the host 200 of the result of speech recognition.

### Working Example 4

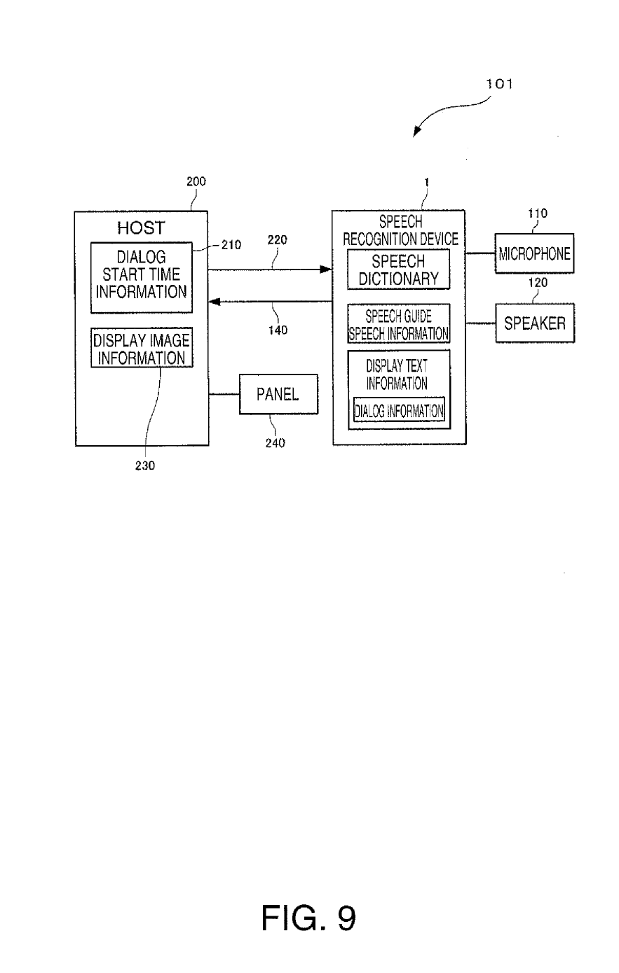

FIG. 9 shows an example of a configuration of a speech processing system 101 according to the present embodiment.

In FIG. 9, a host 200 is configured to output a display image to a panel 240, and the speech processing device 1 does not output a display text.

In this case, similarly to the case of FIG. 8, a dialog start request 220 from the host 200 causes the speech processing device (integrated circuit device) 1 to start execution of a dialog. In accordance with dialog information 42 of the executed dialog, speech guide information 82 is output from a speaker 120.

It should be noted that an interrupt signal 140 for instructing the host 200 to output display information is transmitted, instead of displaying the display text information 72 on the panel 130 in accordance with the dialog information 42 of the executed dialog as in the case of FIG. 8. In response to the interrupt signal 140 from the speech processing device 1, the host 200 displays the display image (display image information 230) on the panel 240.

It should be noted that the above-referenced embodiments and modification examples are merely illustrative and not restrictive. For example, the above-referenced embodiments and modification examples can be combined in plurality as appropriate.

The invention is not limited to the above-referenced embodiments and specific examples. Various other modifications are also possible. For example, the invention embraces configurations that are substantially the same as the configurations described in the embodiments (for example, configurations with the same functions, methods and results, or configurations with the same purposes and effects). The invention also embraces configurations obtained by replacing non-essential portions of the configurations described in the embodiments with others. The invention further embraces configurations that achieve the same functional effects or accomplish the same goal as the configurations described in the embodiments. The invention further embraces configurations obtained by adding known techniques to the configurations described in the embodiments.

What is claimed is:

1. A speech processing device comprising:
a dialog execution control unit that controls speech output and timings of speech recognition in accordance with dialog information including speech output information, speech recognition information and control information;
a speech output control unit that outputs an output speech signal designated by the speech output information under control of the dialog execution control unit; and
a speech recognition unit that executes speech recognition processing for an input speech signal using the speech recognition information under control of the dialog execution control unit, wherein
the control information includes speech output timing information for the output speech signal and speech recognition start timing information for the input speech signal, and
the speech recognition start timing information is specified by a time period that elapses from a first timing specified by the speech output timing information.

2. The speech processing device according to claim 1, wherein
the dialog information includes two or more pieces of the speech output information, and the speech output timing information that specifies output of a predetermined one of the pieces of speech output information is specified by a time period that elapses from completion of output control for one of the pieces of speech output information that is output immediately before an output of the predetermined piece of speech output information.

3. The speech processing device according to claim 1, further comprising
a dialog storage unit that stores the dialog information.

4. The speech processing device according to claim 1, wherein
the first timing is specified by the speech output timing information corresponding to a piece of speech output information that is output last out of pieces of the speech output information included in the dialog information.

5. An integrated circuit device comprising the speech processing device according to claim 1.

6. An integrated circuit device comprising the speech processing device according to claim 2.

7. An integrated circuit device comprising the speech processing device according to claim 3.

8. An integrated circuit device comprising the speech processing device according to claim 4.

9. A speech processing system comprising:
a speech processing device;
a speech input unit;
an information display unit; and
a speech output unit, wherein
the speech processing device includes:
a dialog execution control unit that controls speech output and timings of speech recognition in accordance with dialog information including speech output information, speech recognition information and control information;
a speech output control unit that controls the speech output unit, and outputs an output speech signal designated by the speech output information under control of the dialog execution control unit; and
a speech recognition unit that executes speech recognition processing for an input speech signal output from the speech input unit using the speech recognition information under control of the dialog execution control unit,
the control information includes speech output timing information for the output speech signal, speech recognition start timing information for the input speech signal, and display start timing information for the information display unit, and
the speech recognition start timing information and the display start timing information are specified by a time period that elapses from a first timing specified by the speech output timing information.

10. The speech processing system according to claim 9, wherein
the first timing is specified by the speech output timing information corresponding to a piece of speech output information that is output last out of pieces of the speech output information included in the dialog information.

11. A control method for a speech processing device, comprising
establishing dialog information that includes speech output information, speech recognition information and control information, the control information including speech output timing information and speech recognition start timing information;
outputting the speech output information in accordance with the speech output timing information; and
executing speech recognition processing using the speech recognition information in accordance with the speech recognition start timing information, wherein
the speech recognition start timing information is specified by a time period that elapses from a first timing specified by the speech output timing information.

12. The control method for the speech processing device according to claim 11, further comprising
executing display processing using display information in accordance with display start timing information, the display information being included in the dialog information, and the display start timing information being included in the control information, wherein
the display start timing information is specified by a time period that elapses from the first timing.
